(19) United States
(12) Patent Application Publication
(10) Pub. No.: US 2007/0286403 A1
(43) Pub. Date: Dec. 13, 2007

(54) Amplifier Coupling Coupled Between a Stationary Telephone and a Headset

(76) Inventors: Stefan Gram, Copenhagen (DK); Jesper Birk Petersen, Ishoj (DK)

Correspondence Address: ALTERA LAW GROUP, LLC, 6500 CITY WEST PARKWAY, SUITE 100, MINNEAPOLIS, MN, 55344-7704, US

(21) Appl. No.: 10/588,842

(22) PCT Filed: Feb. 9, 2005
(86) PCT No.: PCT/DK05/00085

§ 371 Date: May 2, 2007

(30) Foreign Application Priority Data
Feb. 9, 2004 (DK) PA 2004 00191

(51) Int. Cl. H04M 1/00

(52) U.S. Cl. 379/395

(57) ABSTRACT

A telephone and a headset have coupled therebetween an amplifier coupling which incorporates circuits with a plurality of transfer characteristics which may be activated by control buttons on the amplifier coupling, allowing a user to adapt the signals received in the speaker to the surrounding sound conditions, thereby improving the sound perception under varying surrounding noise conditions. The transfer characteristics may be of the so-called TT4 standard or may be individually adapted with attenuation and/or gain in selected frequency bands. The amplifier coupling and the stationary telephone have coupled therebetween an automatic gain control (AGC) to adapt signal levels which are fed to the headset from the stationary telephone. The transfer characteristics may be implemented both as fixed circuits selectable via push-buttons, or they may be provided by a PC via a USB port.

The invention relates to an amplifier coupling that is coupled between a stationary telephone and a headset.

Such an amplifier coupling is known from U.S. Pat. No. 5,623,544 which is hereby incorporated by reference. According to this patent, the amplifier coupling is used for powering the amplifier of a headset from a stationary telephone.

As will be known, headsets are not used in stationary mode, of course, but, in contrast, in situations where the user moves about in areas where the acoustic conditions change.

A typical situation may be that the user moves from an office into a production area where the acoustic conditions change from being comparatively noiseless to being noisy, and frequently with noise pictures which may vary quite considerably.

Clearly, if a user conducts a telephone conversation through a headset, then the user's acoustic perception when listening to an incoming call will greatly depend on the acoustic characteristic of the surrounding environment.

In a quiet acoustic environment there will hardly be any problems of understanding an incoming call, but if the call is mixed with strong surrounding noise, then it may be difficult, and even perhaps impossible, to understand the information in the call.

Accordingly, an object of the invention is to adapt a call from a stationary telephone transferred to a headset, such that the sound perception is adapted under various acoustic conditions, in the sense that the sound perception of a signal transferred from the stationary telephone is enhanced.

The object of the invention is achieved by an amplifier coupling of the type defined in the introductory portion of claim 1, which is characterized in that the amplifier coupling is dynamically user-configurable with user-specific transfer characteristics to pass a specific sound picture to the headset.

It is hereby possible to adapt the sound picture emitted in the headset to the acoustic characteristics of the surrounding environment.

It is expedient if, as stated in claim 2, the transfer characteristics are dynamically adaptable in whole or part of the frequency range that represents the sound picture, or as stated in claim 3, said user-specific characteristics include a plurality of said characteristics.

In order to increase the adaptability to certain uses it is advantageous, if as defined in claim 4, the telephone headset includes left and right headsets, and wherein one of said characteristics is fed to the left headset and wherein another characteristic is fed to the right headset, or as defined in claim 5, that one of said characteristics is tuned primarily to transfer voice and the other is tuned primarily to transfer non-voice sounds, or as defined in claim 6, that one characteristic includes a priority override which prioritises one signal over all others and transfers said priority feed to at least one headset in preference to the other feed.

An expedient transfer characteristic may be the user-specific transfer characteristic Telstra Specification TT4, as stated in claim 7. This TT4 specification is a standard specification which is used where full protection against unexpected, undesired sounds is desired.

When, as stated in claim 8, the user-specific transfer characteristic attenuates signals above about 1 KHz, attenuation of high signals is provided, which gives the best sound quality in normal, non-noisy conditions.

When, as stated in claim 9, the user-specific transfer characteristic attenuates signals in the frequency range of about 1-1.5 KHz, while the signals are amplified above about 2 KHz, the headset is adapted to a noisy environment in order to improve the sound perception in the headset.

To ensure suitable noise levels which are transferred from the stationary telephone, it is an advantage if, as stated in claim 10, the amplifier coupling contains an automatic gain control of signals which are applied to the headset, said gain being set on the basis of a signal detected from the stationary telephone.

To ensure that a user is not subjected to unpleasant or even harmful sound impacts, it is an advantage if, as stated in claim 11, the user-specific transfer characteristics contain a maximum permissible amplitude of the signal transferred to the headset in the entire transferred frequency spectrum.

For rapid switching from stationary telephone use to headset use, it is an advantage if, as stated in claim 12, the stationary telephone and the amplifier coupling are interconnected by two wires, and that a switch, such as a bypass coupling, is coupled between the wires.

For use where a headset is used in areas with frequently changing, dis-uniform sound conditions, it is an advantage if, as stated in claim 13, the user-specific transfer characteristics are configured in the amplifier coupling as fixed circuits, where each circuit may be coupled by means of switches.

If it is desired to use the headset under very varying sound conditions requiring a specific transfer characteristic each for optimum perception of the sound in the headset, it is an advantage if, as stated in claim 14, a PC is coupled to the amplifier coupling, said PC being adapted to transfer the user-specific transfer characteristics, and expediently, as stated in claim 15, that the coupling of the PC takes place via a USB gate.

Finally, it is user-friendly if, as stated in claim 16, the coupling of the PC to the amplifier coupling is wireless.

The invention will now be explained more fully with reference to the drawing, in which

FIG. 1 shows a basic coupling of a headset to a stationary telephone with an amplifier coupling according to the invention,

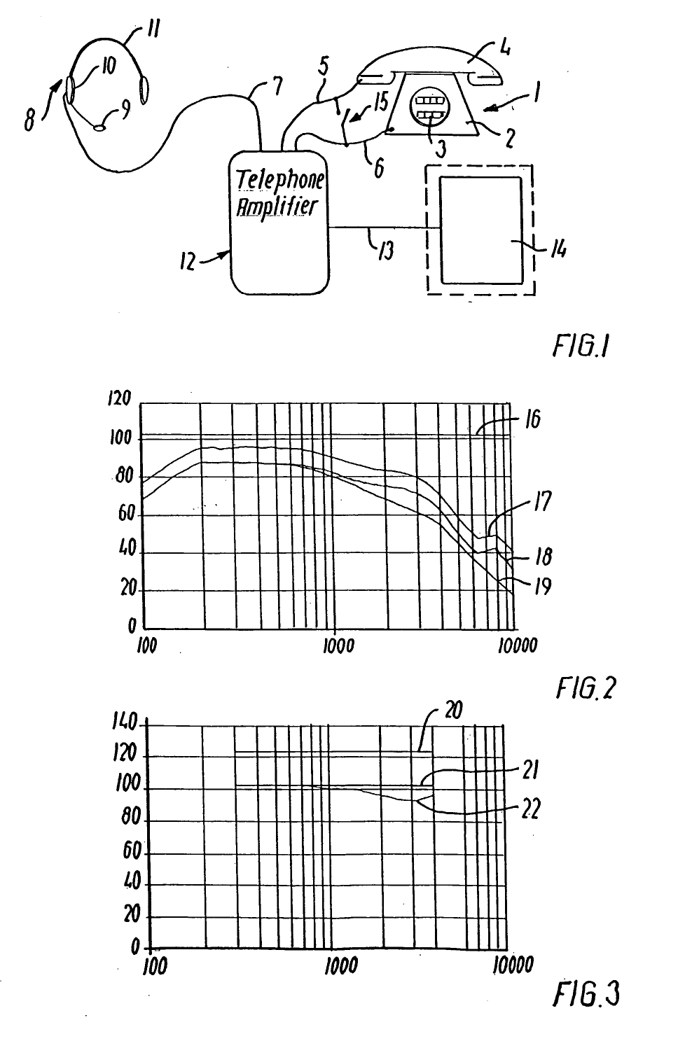

FIG. 2 shows a first transfer characteristic in the amplifier coupling,

FIG. 3 shows a second transfer characteristic in the amplifier coupling, while

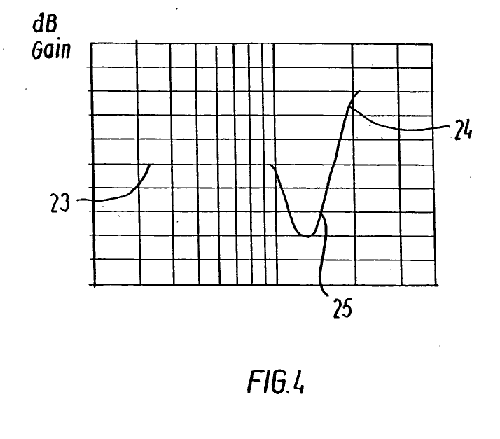

FIG. 4 shows a third transfer characteristic in the amplifier coupling.

In FIG. 1, the numeral 1 designates a telephone (here shown as stationary) consisting of a casing 2 with a keyboard 3, a receiver 4 and a cradle (not shown) between the casing 2 and the receiver 4.

A headset consisting of a dish with a speaker 10 is designated 8.

In addition, the headset 8 has a microphone 9 and a headband 11 to whose one end the dish is connected, while its other end is connected to a further dish, which, however, may be replaced by a support part intended to engage a user's head.

An amplifier coupling 12 is coupled between the stationary telephone 1 and the headset 8.

The headset 8 is coupled to the amplifier coupling 12 by a wire 7, while the stationary telephone 1 is coupled to the amplifier coupling 12 by means of wires 5, 6, of which the wire 5 is coupled to the receiver 4, while the wire 6 is coupled to the casing 2.

Further, a switch 15 is coupled between the wires 5, 6.

Finally, FIG. 1 shows a PC 14 which is coupled to the amplifier coupling 12. This PC, however, is just included as a possible configuration of the setup.

It will now be explained how the setup in FIG. 1 works.

When a call to the stationary telephone 1 is received, it may be answered by either lifting the receiver 4 or by transferring the call to the headset 8 via the amplifier coupling 12. The selection as to whether the receiver 4 or the headset 8 is to be used for answering the call, may be established by using the switch 15, and the position shown in FIG. 1 will direct the call to the headset 8 via the amplifier coupling 12. Note that switch 15 is shown in functional not electrical form. It is intended to indicate a bypass or shunt.

The amplifier coupling 12 incorporates circuits with a plurality of transfer characteristics allowing a user to adapt the signals received in the speaker 10 to the surrounding sound conditions, so that the information received in the headset 8 may be adjusted, thereby improving the sound perception under varying surrounding noise conditions.

This improved sound perception may be provided by selecting a user-specific transfer characteristic which is adapted to the surrounding sound conditions, cf. also the explanation in connection with FIG. 2-FIG. 4 below.

The transfer characteristics may e.g. be included as circuits having three fixed transfer characteristics in the amplifier coupling which may be activated by three control buttons (not shown) on the amplifier coupling. The number of fixed transfer characteristics is unlimited and user selection by buttons/switches or soft-controls is likewise unlimited.

Alternatively, via a PC it is possible to enter user-specific transfer characteristics which, after the entry (download), may e.g. be operated by the control buttons.

An expedient manner of coupling the PC to the amplifier coupling is via the USB gate/port of the PC.

Non-limiting examples of transfer characteristics which may be used under various surrounding sound conditions, will be explained below in connection with FIGS. 2-4.

User-specific sound transfer characteristics may be selected to create a specific sound picture according to user objectives and desires. For example, there may be a desire to suppress/block certain frequency ranges while enhancing the amplitude of others. It is also possible that sophisticated sound patterns (not just specific frequencies) may be blocked or enhanced by storing such patterns and adapting the transfer characteristic to intercept same. Note, that if a sound pattern is to be intercepted, it will be necessary to store an interval of sound in memory (to detect patterns), test the stored memory for a pattern and then enhancing or suppressing as needed. For example, in an airplane cockpit, aircraft motor noise, for example has a mean periodicy which could be blocked, while a siren/alarm might need to be enhanced.

FIG. 2 shows a so-called TT4 standard, which is a standard providing the best protection against unexpected and undesired sounds. This standard ensures full protection of a user's ears, as it removes any unpleasant impact from sudden and unexpected sounds during a telephone conversation.

This transfer characteristic incorporates an upper limit 18 for the sound level which is allowed to pass to the speaker 10, while 17, 18, and 19 show three measured transfer characteristics which in principle have fairly the same course, particularly in the upper frequency range.

FIG. 3 shows a transfer characteristic which again has an upper sound limit 20, 21, of which 20 shows a maximum peak value, while 21 shows a maximum mean value, which are allowed to pass to the speaker 10.

As will additionally be seen at the curve 22, the signal is attenuated at high frequencies, which is the most commonly used transfer characteristic. It has a transfer ratio of 1:1, when noise impacts are disregarded. This transfer characteristic gives the best sound quality under normal conditions.

Finally, FIG. 4 shows a transfer characteristic where there is a constant gain, shown at 23, in the low frequency range, while there is an attenuation, shown at 25, in the lower part of the higher frequency range, and there is a gain, shown at 24, in the higher part of the higher frequency range.

This transfer characteristic is capable of providing a better sound perception in noisy surroundings. Further, it may be favourable to users suffering from impaired hearing.

It should be noted that a particularly advantageous way of switching between the three above-mentioned transfer characteristics may be implemented by providing push-buttons in a row on the headset, where the central button is used for the coupling of the most used characteristic.

In addition to use of the present invention to permit different transfer characteristics to be applied to the amplifier in series, there are other ways to take advantage of this technique, which in the following will be illustrated more detailed.

For example, using different transfer characteristics may also be used advantageously in parallel, especially, but not exclusively, in dual headsets (i.e. a headset on both ears).

In addition to changing the transfer characteristics according to the amplifier, it may be desirable to change that characteristic separately for each ear. In the case of a headset with twin (left/right) headsets, the amplifier can be programmed to use a separate transfer characteristic for each ear. The purpose could be, to compensate for hearing sensitivity variations between ears, but there are other possibilities.

In general, the use of parallel feeds, processed differently through different transfer characteristics, allows the user to create a number of useful results. For example, prioritisation of multiple feeds (signals) based on an amplitude or filtration of frequencies or other predetermined characteristics can be used to alert a user of important data. One application would be to apply different transfer characteristics to each headset. A voice transfer characteristic could be applied to one ear, while a siren-bypass characteristic to the other. Thus, a person could use a headset to enhance normal speech transmission in a noisy environment, while allowing certain critical sounds (sirens, warning tones, sounds recognised as engine failure etc.) to pass to the other ear. It would also be possible to accomplish the same in a single headset system where the two characteristics would be applied in parallel. This parallel overlay would allow the user to select two or more transfer characteristics tuned for different objectives to be applied simultaneously.

Of course, this has applications for hearing impaired users, where tuned characteristics are of great importance. By using a dual headset (or two hearing aids), one could be tuned to voice and the other for emergency/distress frequencies.

Another application would be for a person to listen to sounds from separate sources (feeds), preferably, but not necessarily, one in each ear. For example, a pilot might receive filtered voice communications from his/her surrounding environment in one ear and ATC (air traffic control) in the other. In such circumstance, the feed from ATC would likely be louder than ambient conversations. But unlike feeding both signals into the same headset, the user could elect to focus on one feed or the other by merely pushing one headset (temporarily) off one ear.

Prioritisation of messaging which can be accomplished by using amplifier different transfer characteristics in the same headset.

One application would be in the well-known noise cancelling headsets, for example, used widely by airplane passengers to suppress aircraft engine noise on long flights. Such headsets require different transfer characteristics to suppress background noises of different types. A user might be willing to totally suppress noise in one ear but need to allow a small amount the passthrough in the other to be sure that important information (like emergency announcements, low level speech, etc.) is not missed entirely. Likewise, a dispatcher or other multitasking user may need to receive different information in each ear and at different levels.

In the case of a single headset which can be worn on the left or right side, the left/right reversibility can be advantageously combined with the transfer characteristic system above.

Since a single headset having a microphone element, usually a boom, is essentially used upside down when placed on the other ear, a position sensor on the headset can be provided to automatically select the appropriate transfer characteristic or source feed without specific user intervention or selection.

A gravity responsive switch, either mechanical or electronic, can detect headset position. Likewise, the position of the headset boom or microphone 9, which pivots generally from proximate the headset, can include a sensor to detect which way the headset is worn (left or right ear), and direct a particular feed or transfer characteristic to that ear.

In a multilingual environment, the headset can be configured to select one language feed when worn on the right and another when worn on the left. For example, in a flight simulator or other training environment, the headset could have the sound feed in English when worn on the right ear and French when worn on the left. No user switch would be required.

In an interactive video game environment, the choice of ear might determine the type of voice prompts the game player might receive. For example, on the left ear, the player might receive game clues, while on the other ear, the player might only receive the background sounds. Another practical application in team-internet gaming is that one ear could be used for opposing players and the other ear for co-team members. It would be further possible to use a transfer characteristic which altered the speech of the competitor (or injected a warning tone), so that the headset wearer did not get confused.

A similar use might be for police/military where ambient sounds would come into one ear, while intelligence reports/scouts/etc., would come into the other.

Other applications which depend on the orientation of the headset are also possible.

Another application of this concept would be where it would be desirable to provide a selection of dialects within the same language (f.ex. British vs American) or of voice pitches (female vs. male voice), so that certain users could select a voice feed most comfortable to their needs, merely by selecting whether to wear the headset on one ear or the other.

Of course the position-sensing headset, which directs a particular feed to a particular headset (single or dual), could be advantageously combined with the transfer characteristic methodology mentioned above. Such a combination would provide a very customisable environment.

Although the invention has been explained in connection with the three shown characteristics and a specific type of headset, nothing within the scope of the claims prevents the principles of the invention from being used with other transfer characteristics and other headsets, e.g. headsets of the type which may be hooked on an ear and is connected to a Bluetooth connection.

Moreover, it is possible to replace the wiring between the stationary telephone, the hearing device, a headset, the amplifier coupling and the PC by wireless connections, e.g. of the type Bluetooth or Dect (European Standard for wireless phones) or equivalent.

1. An amplifier that is coupled between a telephone and a headset, wherein the amplifier is dynamically user-configurable with user-specific transfer characteristics to pass a specific sound picture to the headset, and in that said transfer characteristics are dynamically adaptable in whole or part of the frequency range that represents the sound picture.

2. (canceled)

3. An amplifier coupling according to claim 1, wherein said user-specific characteristics include a plurality of said characteristics.

4. An amplifier according to claim 3, wherein the telephone headset includes left and right headsets earphones, and wherein one of said characteristics is fed to the left headset earphone and wherein another characteristic is fed to the right headset earphone.

5. An amplifier according to claim 4, wherein one of said characteristics is tuned primarily to transfer voice and the other is tuned primarily to transfer non-voice sounds.

6. An amplifier according to claim 3, wherein one characteristic includes a priority override which prioritizes one signal over all others and transfers said priority feed to at least one headset earphone in preference to the other feed.

7. An amplifier according to claim 1, wherein the user-specific transfer characteristic is Telstra Specification TT4.

8. An amplifier according to claim 1, wherein the user-specific transfer characteristic attenuates signals above about 1 KHz.

9. An amplifier coupling according to claim 1, wherein the user-specific transfer characteristic attenuates signals in the frequency range of about 1-1.5 KHz, while the signals are amplified above about 2 KHz.

10. An amplifier according to claim 1, wherein it contains an automatic gain control of signals fed to the headset, said gain being set on the basis of a signal detected from the stationary telephone.

11. An amplifier according to claim 1, wherein the user-specific transfer characteristics contain a maximum permissible amplitude of the signal transferred to the headset in the entire transferred frequency spectrum.

12. An amplifier according to claim 1, wherein the telephone and the amplifier are interconnected by two wires, and that a switch, such as a bypass coupling, is coupled between the wires.

13. An amplifier according to claim 1, wherein the user-specific characteristics are configured in the amplifier as fixed circuits, where each circuit may be coupled by switches.

14. An amplifier according to claim 1, wherein a PC adapted to transfer the user-specific transfer characteristics is coupled to the amplifier.

15. An amplifier according to claim 14, wherein the coupling of the PC takes place via a USB port.

16. An amplifier according to claim 14, wherein the coupling of the PC to the amplifier is wireless.
